(19) United States
(12) Patent Application Publication
(10) Pub. No.: US 2011/0201336 A1
(43) Pub. Date: Aug. 18, 2011

(54) METHOD AND SYSTEM FOR OPTIMIZING USER-LEVEL QoS DURING A LOCATION-BASED HANDOFF OVER HETEROGENEOUS MOBILE ENVIRONMENTS

(76) Inventors: David Garrett, Tustin, CA (US); Charles Abraham, Los Gatos, CA (US); Mark Buer, Gilbert, AZ (US); Jeyhan Karaoguz, Irvine, CA (US); David Albert Lundgren, Mill Valley, CA (US); David Murray, Mission Viejo, CA (US)

(21) Appl. No.: 12/729,208

(22) Filed: Mar. 22, 2010

Related U.S. Application Data
(60) Provisional application No. 61/304,262, filed on Feb. 12, 2010.

(51) Int. Cl. H04W 36/34

(52) U.S. Cl. 455/436

(57) ABSTRACT

A multi-radio mobile device receives data transmission of a session from a serving access network in a heterogeneous network system comprising difference access networks. A handoff is performed based on the received data transmissions. User-level QoS for the wireless communication session is adjusted during the handoff based on connection QoS information in the current location of the multi-radio mobile device and/or a velocity of the multi-radio mobile device. Location-based network connection information, comprising call drop information and the connection QoS information, in the current location of the multi-radio mobile device is acquired from a location server. A target access network or a different base station in the serving access network associated with the highest connection QoS is selected. The user-level QoS is adjusted during the handoff for receiving the wireless communication session from the selected target access network or the different base station in the serving access network.

### CROSS-REFERENCE TO RELATED APPLICATIONS/INCORPORATION BY REFERENCE

This patent application makes reference to, claims priority to and claims the benefit from U.S. Provisional Patent Application Ser. No. 61/304,262 filed on Feb. 12, 2010.

This application also makes reference to U.S. application Ser. No. 12/729,202 filed on Mar. 22, 2010.

Each of the above stated applications is hereby incorporated herein by reference in its entirety.

### FIELD OF THE INVENTION

Certain embodiments of the invention relate to communication systems. More specifically, certain embodiments of the invention relate to a method and system for optimizing user-level QoS during a location-based handoff over heterogeneous mobile environments.

### BACKGROUND OF THE INVENTION

Next generation mobile networks will utilize several different radio access technologies such as, for example, Global System for Mobile Communications (GSM), Universal Mobile Telecommunications System (UMTS), 3GPP Long Term Evolution (LTE), wireless local area networks (WLAN), Bluetooth networks and Worldwide Interoperability for Microwave Access (WiMAX) networks integrated to form a heterogeneous wireless access network system. Different radio access networks provide different levels of capacity and coverage to end users. A wide variety of services are delivered to end users over the heterogeneous wireless access network system using different radio access technologies. The utilization of the heterogeneous wireless access network system assures end users enhanced network connection any where any time so as to improve the quality of service. In particular, a seamless and efficient vertical handoff between different radio access technologies is essential in the heterogeneous wireless access network system to ensure an uninterrupted wireless communication session reception during the movement of a mobile device. The vertical handoff is a next-generation network concept against a horizontal handoff, which is a handoff performed between different base stations or access points using the same radio access technology.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for optimizing user-level QoS during a location-based handoff over heterogeneous mobile environments, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to optimize user-level QoS during a location-based vertical handoff in a heterogeneous network system, in accordance with an embodiment of the invention.

FIG. 2 is a block diagram illustrating an exemplary multi-radio mobile device that is operable to optimize user-level QoS during a location-based vertical handoff in a heterogeneous network system, in accordance with an embodiment of the invention.

FIG. 3 is a block diagram illustrating an exemplary location server that is operable to provide location-based network connection information to associated mobile devices to optimize user-level QoS during a location-based vertical handoff, in accordance with an embodiment of the invention.

FIG. 4 is a flow chart illustrating an exemplary procedure that is utilized to optimize user-level QoS during a location-based vertical handoff in a heterogeneous network system, in accordance with an embodiment of the invention.

### DETAILED DESCRIPTION OF THE INVENTION

Certain embodiments of the invention may be found in a method and system for optimizing user-level QoS during a location-based handoff over heterogeneous mobile environments. In various embodiments of the invention, a multi-radio mobile device is operable to receive data transmissions of a wireless communication session from a serving access network in a coupled heterogeneous network system comprising a plurality of difference access networks. The multi-radio mobile device is operable to perform a handoff, from the serving access network to another one of the plurality of different access networks, over the wireless communication session based on the received data transmissions. User-level QoS for the wireless communication session may be adjusted based on connection QoS information for a current location of the multi-radio mobile device during the handoff. The multi-radio mobile device is operable to acquire location-based network connection information in the vicinity or proximity of the current location of the multi-radio mobile device from a location server. The acquired location-based network connection information comprises call drop information and the connection QoS information in the current location of the multi-radio mobile device. One or more available access networks may be identified based on the call drop information. A target access network associated with the highest connection QoS may be selected from the identified available access networks based on the connection QoS information. The multi-radio mobile device is operable to adapt the user-level QoS to connection QoS of the selected target access network (the highest connection QoS) during the handoff. The user-level QoS maintains a fixed value during the handoff when the highest connection QoS matches the user-level QoS. The user-level QoS may be upgraded or downgraded, respectively, during the handoff when the highest connection QoS exceeds or fails to fulfill the user-level QoS. The user-level QoS may also be adjusted based on an actual velocity of the multi-radio device. When a handoff within the serving access network occurs, the user-level QoS may be adapted to connection QoS of a different base station in the serving access network during the handoff.

The multi-radio mobile device may complete the vertical handoff process with receiving data transmission of the wireless communication session from the selected target access network using the adapted user-level QoS.

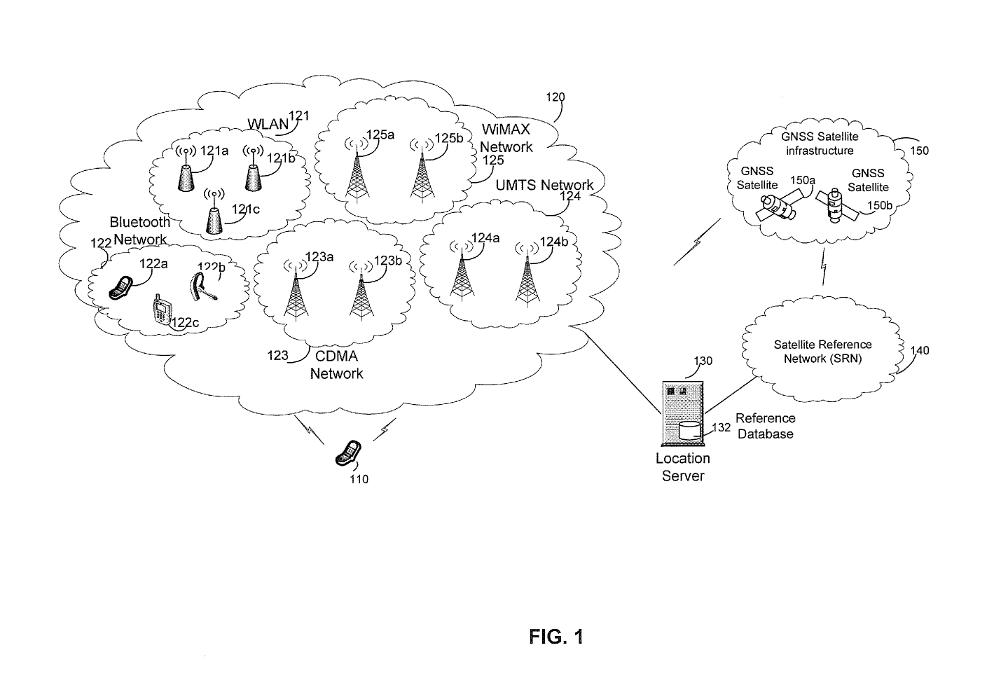

FIG. 1 is a diagram illustrating an exemplary communication system that is operable to optimize user-level QoS during a location-based vertical handoff in a heterogeneous network system, in accordance with an embodiment of the invention. Referring to FIG. 1, there is shown a communication system 100. The communication system 100 comprises a multi-radio mobile device 110, a heterogeneous network system 120, a location server 130 comprising a reference database 132, a satellite reference network (SRN) 140 and a Global Navigation Satellite Systems (GNSS) satellite infrastructure 150. The heterogeneous network system 120 comprises a plurality of different radio access networks, of which a WLAN 121, a Bluetooth network 122, a CDMA network 123, a UMTS network 124 and a WiMAX network 125 are illustrated.

The multi-radio mobile device 110 may comprise suitable logic, circuitry, interfaces and/or code that are operable to communicate radio frequency signals with a plurality of mobile communication access networks such as, for example, the WLAN 121, the Bluetooth network 122, the CDMA network 123, the UMTS network 124 and/or the WiMAX network 125 to receive various services such as a location-based service. The location of the multi-radio mobile device 110 may be determined utilizing various means to support the location-based service. For example, in instances where the multi-radio mobile device 110 is GNSS-capable, the multi-radio mobile device 110 may be operable to receive GNSS signals from visible GNSS satellites such as the GNSS satellites 162-166. The received GNSS signals may be utilized to determine the location of the multi-radio mobile device 110. In instances where the multi-radio mobile device 110 is not GNSS-capable, the location of the multi-radio mobile device 110 may be determined utilizing information of an associated serving access network. For example, locations and/or transmit timing information of three or more radio sites, namely, base stations or access points, in the associated serving access network may be utilized to determine the location of the multi-radio mobile device 110.

Depending on device capabilities, the multi-radio mobile device 110 may be operable to capture location-based network connection information of encountered serving access networks in corresponding locations. The captured location-based network connection information comprises network connection availability information such as, for example, call drop or service loss, and connection QoS. Connection QoS may comprise various connection's QoS requirements such as, for example, jitter (playout delay), latency, bandwidth and packet loss. The captured location-based network connection information may be time stamped to be transmitted to, for example, the location server 130. The transmitted location-based network connection information may be stored in the reference database 132 and shared with other mobile devices associated with the location server 130. In this regard, the multi-radio mobile device 110 may be operable to share location-based connection information contributed from other mobile devices. In instance where the multi-radio mobile device 110 in the vicinity or proximity of a specific location may experience a low received signal power or high RF interference on an on-going wireless communication session from a current serving network such as the UMTS network 124.

The multi-radio mobile device 110 may be operable to communicate with the location server 130 so as to acquire location-based network connection information for the specific location in the time period of interest. The multi-radio mobile device 110 may be operable to utilize the acquired location-based network connection information to determine whether a vertical handoff in the specific location and/or surrounding areas may be needed or required in order to maintain the reception of the on-going wireless communication session from the UMTS network 124. In instances where the acquired location-based connection information may indicate a low call drop rate or service loss rate in the UMTS network 124 in the specific location, the multi-radio mobile device 110 may be operable to determine not to handoff the on-going wireless communication session to another access network such as the WLAN 121.

The multi-radio mobile device 110 may be operable to continue receiving the on-going wireless communication session from the UMTS network 124 despite of the low received power or high RF interference. In instances where the acquired location-based connection information may indicate a high call drop rate or service loss rate in the UMTS network 124 in the specific location and/or surrounding areas, the multi-radio mobile device 110 may be operable to determine whether to handoff the on-going wireless communication session from the UMTS network 124 to another available access network. The handoff decision may be determined based on the acquired location-based connection information and the actual velocity of the multi-radio mobile device 110. In instances where the multi-radio mobile device 110 is moving fast through the UMTS network 124, the handoff decision may be deferred. In this regard, the multi-radio mobile device 110 may be locked onto the UMTS network 124 as long as possible to reduce network re-establish time even with a lower data rate.

In instances where the multi-radio mobile device 110 is moving slowly through the UMTS network 124, the handoff decision may be made for the multi-radio mobile device 110 to be switched from the UMTS network 124 to another available access network. In this regard, one or more available access networks associated with lower call drop rates or service loss rates in the specific location and/or surrounding areas may be identified based on the acquired location-based network connection information. Connection QoS of the identified one or more available access networks may be evaluated and/or ranked based on the acquired location-based network connection information. A specific identified access network associated with the highest connection QoS may be selected as a target access network for a vertical handoff in the specific location and/or surrounding areas. The connection QoS of the selected target access network may match, fail to fulfill, or exceed user-level QoS for the wireless communication session. The user-lever QoS indicates QoS requirements for a users' perceived quality of the on-going wireless communication session. In other words, the user-lever QoS indicates QoS needs from the users on the wireless communication session. In this regard, the multi-radio mobile device 110 may be operable to optimize the user-level QoS during the vertical handoff process. Specifically, the multi-radio mobile device 110 may be operable to adapt the user-level QoS to the connection QoS of the selected target access network to improve the user-level QoS during the vertical.

In instances where the connection QoS of the selected target access network may provide a QoS matching the current user-level QoS for the on-going wireless communication session, the multi-radio mobile device 110 may be operable to maintain the user-level QoS for the on-going wireless communication session a fixed value during the vertical handoff process. The multi-radio mobile device 110 may be operable to establish connections with the selected target access network to continue receiving the wireless communication session. The selected target access network may function as a replacement for the current access network and operate as a new access network with respect to the multi-radio mobile device 110. Data transmission of the on-going wireless communication session may be received from the new serving access network with the completion of the vertical handoff process.

In instances where the connection QoS of the selected target access network may provide a QoS exceeding the current user-level QoS for the on-going wireless communication session, the multi-radio mobile device 110 may be operable to enhance the user-level QoS for the on-going wireless communication session during the vertical handoff process. The multi-radio mobile device 110 may be operable to upgrade or scale up the current user-level QoS for the on-going wireless communication session based on the connection QoS of the selected target access network. For example, the multi-radio mobile device 110 may be operable to upgrade or enhance the user-level QoS for a VoIP application by reducing delay requirement. The multi-radio mobile device 110 may be operable to establish connections with the selected target access network to continue receiving the wireless communication session using the upgraded user-level QoS. The selected target access network may function as a replacement for the current access network and operate as a new access network to the multi-radio mobile device 110. Data transmission of the on-going wireless communication session may be received using the upgraded user-level QoS from the new serving access network with the completion of the vertical handoff process.

In instances where the connection QoS of the selected target access network may fail to fulfill the current user-level QoS for the on-going wireless communication session, the multi-radio mobile device 110 may be configured to fulfill, for example, a minimum user-level QoS during the vertical handoff. In this regard, the multi-radio mobile device 110 may be operable to downgrade or scale down the current user-level QoS for the on-going wireless communication session based on the connection QoS of the selected target access network. For example, the multi-radio mobile device 110 may be operable to downgrade the user-level QoS for a video application by reducing the frame rate and/or picture resolution size expected in the reception. The multi-radio mobile device 110 may be operable to establish connections with the selected target access network to continue receiving the wireless communication session using the downgraded user-level QoS. The selected target access network may function as a replacement for the current access network and operate as a new access network to the multi-radio mobile device 110. Data transmission of the on-going wireless communication session may be received using the downgraded user-level QoS from the new serving access network with the completion of the vertical handoff process.

The heterogeneous network system 120 may comprise suitable logic, circuitry, interfaces and/or code that are operable to provide QoS enabled connections between a wireless mobile device such as the multi-radio mobile device 110 and an optimum wireless communication system or network according to usage and/or moving state such as, for example, mobility status, of the multi-radio mobile device 110. Various different radio access technologies may be utilized in the heterogeneous network system 120 to provide the multi-radio mobile device 110 with an access to a wireless communication session of interest. In particular, the heterogeneous network system 120 may be operable to support a vertical handoff between different access networks such as, for example, the WLAN 121, the UMTS network 124 and/or a WiMAX network 125, so as to maintain continuity of the wireless communication session on the multi-radio mobile device 110.

The WLAN 121 may comprise suitable logic, circuitry, interfaces and/or code that are operable to provide data services to various wireless LAN enabled communication devices such as the multi-radio mobile device 110 using wireless LAN technology. Exemplary wireless LAN technology may comprise, for example, IEEE Std 802.11, 802.11a, 802.11b, 802.11d, 802.11e, 802.11g, 802.11n, 802.11v, and/or 802.11u. The WLAN 121 comprises a plurality of WLAN access points such as WLAN access points (APs) 121a through 121c. The WLAN 121 may be operable to communicate various data services such as a location-based service (LBS) over WLAN connections between the WLAN APs 121a through 121c and corresponding WLAN capable devices such as, for example, the multi-radio mobile device 110. In this regard, a QoS enabled WLAN connection between, for example, the WLAN AP 121a and the multi-radio mobile device 110 may be location stamped using the location of the multi-radio mobile device 110. Connection status such as call drop or service loss, and/or connection QoS of the location stamped WLAN connection may be communicated to the location server 130 to support a vertical handoff between different radio access technologies in the heterogeneous network system 120, and/or an user-level QoS optimization during the vertical handoff when needed.

The Bluetooth network 122 may comprise suitable logic, circuitry, interfaces and/or code that are operable to provide data services to various Bluetooth enabled mobile devices such as the multi-radio mobile device 110 using Bluetooth technology. Exemplary Bluetooth technology may comprise, for example, IEEE Std IEEE 802.15 WPAN and/or IEEE 802.15.4. The Bluetooth network 122 comprises a plurality of Bluetooth capable mobile devices such as Bluetooth mobile devices 122a through 122c. The Bluetooth network 122 may be operable to communicate various data services such as a location-based service (LBS) over QoS enabled Bluetooth connections between, for example, the multi-radio mobile device 110 and a peer Bluetooth device such as the Bluetooth mobile device 122a. In this regard, the QoS enabled Bluetooth connection between multi-radio mobile device 110 and the Bluetooth mobile device 122a may be location stamped using the location of the multi-radio mobile device 110. Connection status such as call drop or service loss, and/or connection QoS of the location stamped Bluetooth connection may be communicated to the location server 130 to support a vertical handoff between different radio access technologies in the heterogeneous network system 120, and/or an user-level QoS optimization during the vertical handoff when needed.

The CDMA network 123 may comprise suitable logic, circuitry, interfaces and/or code that are operable to provide data services to various CDMA enabled mobile devices such as the multi-radio mobile device 110 using CDMA technology. The CDMA network 123 comprises a plurality of base stations such as base stations 123a through 123b. The CDMA network 123 may be operable to communicate various data services such as a location-based service (LBS) over QoS enabled CDMA connections between, for example, the multi-radio mobile device 110 and a CDMA base station such as the base station 123a. In this regard, the QoS enabled CDMA connection between the multi-radio mobile device 110 and the base station 123a may be location stamped using the location of the multi-radio mobile device 110. Connection status such as call drop or service loss, and/or connection QoS of the location stamped CDMA connection may be communicated to the location server 130 to support a vertical handoff between different radio access technologies in the heterogeneous network system 120, and/or an user-level QoS optimization during the vertical handoff when needed.

The UMTS network 124 may comprise suitable logic, circuitry, interfaces and/or code that are operable to provide data services to various UMTS enabled mobile devices such as the multi-radio mobile device 110 using UMTS technology. The UMTS network 124 comprises a plurality of base stations such as base stations 124a through 124b. The UMTS network 124 may be operable to communicate various data services such as a location-based service (LBS) over QoS enabled UMTS connections between, for example, the multi-radio mobile device 110 and a UMTS base station such as the base station 124a. In this regard, the QoS enabled UMTS connection between multi-radio mobile device 110 and the base station 124a may be location stamped using the location of the multi-radio mobile device 110. Connection status such as call drop or service loss, and/or connection QoS of the location stamped UMTS connection may be communicated to the location server 130 to support a vertical handoff between different radio access technologies in the heterogeneous network system 120, and/or an user-level QoS optimization during the vertical handoff when need.

The WiMAX network 125 may comprise suitable logic, circuitry, interfaces and/or code that are operable to provide data services to various WiMAX enabled mobile devices such as the multi-radio mobile device 110 using WiMAX technology. The WiMAX network 125 comprises a plurality of base stations such as base stations 125a through 125b. The WiMAX network 125 may be operable to communicate various data services such as a location-based service (LBS) over QoS enabled WiMAX connections between, for example, the multi-radio mobile device 110 and a WiMAX base station such as the base station 125a. In this regard, the QoS enabled WiMAX connection between multi-radio mobile device 110 and the base station 125a may be location stamped using the location of the multi-radio mobile device 110. Connection status such as call drop or service loss, and/or connection QoS of the location stamped WiMAX connection may be communicated to the location server 130 to support a vertical handoff between different radio access technologies in the heterogeneous network system 120, and/or an user-level QoS optimization during the vertical handoff.

The location server 130 may comprise suitable logic, circuitry, interfaces and/or code that are operable to access the satellite reference network (SRN) 140 to collect GNSS satellite data by tracking GNSS constellations through the SRN 140. The location server 130 may be operable to utilize the collected GNSS satellite data to generate GNSS assistance data comprising, for example, ephemeris data, LTO data, reference positions and/or time information. The location server 130 may be operable to collect and/or retrieve location related information for associated users. The location server 130 may be operable to receive a plurality of location-based network connection information from associated mobile devices such as the multi-radio mobile device 110 as well as associated access networks, for example, the UMTS network 124 and the WiMAX network 125. The received location-based network connection information may be stored in the reference database 132 in order to be shared among associated mobile devices such as the multi-radio mobile device 110. The location-based network connection information from, for example, the multi-radio mobile device 110 may indicate network connection information such as, for example, call drop or service loss, and/or connection QoS, of a serving access network with respect to the location of the multi-radio mobile device 110. Upon receiving requests for location-based network connection information from, for example, the multi-radio mobile device 110, the location server 130 may be operable to collect location-based network information in the vicinity or proximity of the location of the multi-radio mobile device 110 from the reference database 132. The collected location-based network information may be communicated as GNSS assistance data to the multi-radio mobile device 110.

The SRN 140 may comprise suitable logic, circuitry, interfaces and/or code that are operable to collect and/or distribute data for GNSS satellites on a continuous basis. The SRN 140 may comprise a plurality of GNSS reference tracking stations located around the world to provide assistant GNSS (A-GNSS) coverage all the time in both a home network and/or any visited network.

The GNSS satellites 150a through 150b may comprise suitable logic, circuitry, interfaces and/or code that may be operable to generate and broadcast satellite navigational information. The broadcast satellite navigational information may be collected by the SRN 140 to be utilized by the location server 130 to enhance LBS services. The GNSS satellites 150a through 150b may comprise GPS, Galileo, and/or GLONASS satellites.

In an exemplary operation, the location server 130 may be operable to collect location-based network connection information from associated communication devices such as, for example, the multi-radio mobile device 110. The collected location-based network connection information may be stored in the reference database 132 to be shared among a plurality of mobile devices associated with the location server 130. For example, the multi-radio mobile device 110 in a specific location may experience a low received signal power on data transmissions of an on-going wireless communication session from a serving network such as the UMTS network 124. The multi-radio mobile device 110 may be operable to send a request comprising, for example, its own location for location-based network connection information to the location server 130. The location server 130 may be operable to identify and/or extract location-based network connection information comprising, for example, call drop and/or connection QoS, in the vicinity or proximity of the location of the multi-radio mobile device 110 from the reference database 132. The identified location-based network connection information may be communicated as GNSS assistance data to the multi-radio mobile device 110. A call drop rate or a service loss rate in a current serving access network, namely, the UMTS network 124, may be determined with respect to the vicinity of the location of the multi-radio mobile device 110 based on the location-based network connection information in the received GNSS assistance data. In instances where the determined call drop rate or service loss rate in the UMTS network 124 may be low, the multi-radio mobile device 110 may be operable to determine not to perform a vertical handoff on the on-going wireless communication session. The multi-radio mobile device 110 may be operable to continue receiving data transmissions of the wireless communication session from the UMTS network 124 regardless of the low received signal power. In instances where the determined call drop rate or service loss rate is high and the multi-radio mobile device 110 is passing the UMTS network 124 fast, the multi-radio mobile device 110 may still stay with the UMTS network 124 as long as possible so as to save power even with a lower data rate. In instances where the determined call drop rate or service loss rate is high and the multi-radio mobile device 110 is slowly passing the UMTS network 124, the multi-radio mobile device 110 may be operable to determine to handoff the on-going wireless communication session from the UMTS network 124 to another available access network for an uninterrupted service reception. One or more available access networks associated with lower call drop rates or service loss rates in the location of the multi-radio mobile device 110 and/or surrounding areas may be identified based on the acquired location-based network connection information. A target access network associated with the highest connection QoS may be selected from the identified available access networks for a vertical handoff in the location of the multi-radio mobile device 110 and/or surrounding areas. User-level QoS for the wireless communication session may be fixed or refreshed based on the connection QoS of the selected target access network. In instances where the connection QoS of the selected target access network may match the current user-level QoS for the on-going wireless communication session, the user-level QoS may maintain a fixed value during the handoff process. Otherwise, the multi-radio mobile device 110 may be operable to adjust the current user-level QoS for the wireless communication session based on the connection QoS of the selected target access network. The user-level QoS may be upgraded or downgraded based on the connection QoS of the target access network. The multi-radio mobile device 110 may be operable to establish or set up connections with the selected target access network (the WLAN 121) for the on-going wireless communication session. The WLAN 121 may function as a replacement for the current serving access network serving as a new access network to the multi-radio mobile device 110. The multi-radio mobile device 110 may be operable to continue receiving data transmissions of the on-going wireless communication session from the new serving access network, namely, the WLAN 121.

Although optimization of user-level QoS during a location-based vertical handoff in a heterogeneous network system is illustrated in FIG. 1, the invention need not be so limited. Accordingly, optimization of user-level QoS during a location-based homogenous handoff, namely, a location-based handoff between the same radio access technologies, may be supported to handoff an on-going wireless communication session from a current serving base station to a different base station within the same access network without departing from the spirit and scope of various embodiments of the invention.

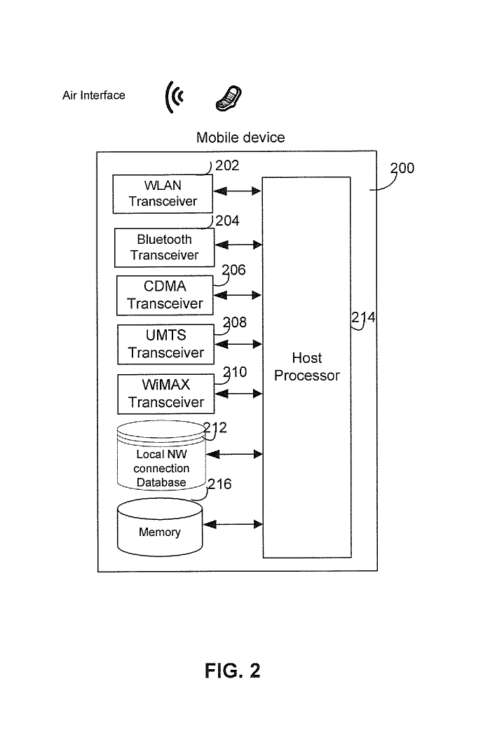

FIG. 2 is a block diagram illustrating an exemplary multi-radio mobile device that is operable to optimize user-level QoS during a location-based vertical handoff in a heterogeneous network system, in accordance with an embodiment of the invention. Referring to FIG. 2, there is shown a multi-radio mobile device 200. The multi-radio mobile device 200 comprises a WLAN transceiver 202, a Bluetooth transceiver 204, a CDMA transceiver 206, a UMTS transceiver 208, a WiMAX transceiver 210, a local network connection database 212, a host processor 214 and a memory 216.

The WLAN transceiver 202 may comprise suitable logic, circuitry, interfaces and/or code that may be operable to receive and/or transmit radio frequency signals using wireless LAN technology. The WLAN transceiver 202 may be operable to transmit and/or receive radio frequency (RF) signals over WLAN connections with various WLAN APs such as the WLAN AP 121a. The WLAN connections may be QoS enabled transport connections.

The Bluetooth transceiver 204 may comprise suitable logic, circuitry, interfaces and/or code that may be operable to receive and/or transmit radio frequency signals using Bluetooth technology. The Bluetooth transceiver 204 may be operable to transmit and/or receive radio frequency (RF) signals over Bluetooth connections with various peer Bluetooth devices such as, for example, the Bluetooth mobile device 122b. The Bluetooth connections may be QoS enabled transport connections.

The CDMA transceiver 206 may comprise suitable logic, circuitry, interfaces and/or code that may be operable to receive and/or transmit radio frequency signals using CDMA technology. The CDMA transceiver 206 may be operable to transmit and/or receive radio frequency (RF) signals over CDMA connections with a serving base station such as the base station 123a in the CDMA network 123. The CDMA connections may be QoS enabled transport connections.

The UMTS transceiver 208 may comprise suitable logic, circuitry, interfaces and/or code that may be operable to receive and/or transmit radio frequency signals using UMTS technology. The UMTS transceiver 208 may be operable to transmit and/or receive radio frequency (RF) signals over UMTS connections with a serving base station such as the base station 124a in the UMTS network 124. The UMTS connections may be QoS enabled transport connections.

The WiMAX transceiver 210 may comprise suitable logic, circuitry, interfaces and/or code that may be operable to receive and/or transmit radio frequency signals using WiMAX technology. The WiMAX transceiver 210 may be operable to transmit and/or receive radio frequency (RF) signals over WiMAX connections with a serving base station such as the base station 125a in the WiMAX network 125. The WiMAX connections may be QoS enabled transport connections.

The local network connection database 212 may comprise suitable logic, circuitry, interfaces and/or code that may be operable to manage and store data comprising network connection information such as call drop or service loss, and/or connection QoS of network connections that the multi-radio mobile device 200 encounters with regard to corresponding location information. The contents of the local network connection database 212 may provide information on how each available network may perform with respect to usability, capacity and/or reliability of network connections in the vicinity or proximity of the location of the multi-radio mobile device 200. In this regard, the contents of the local network connection database 212 may be utilized to determine whether a vertical handoff between different radio access networks in the heterogeneous network system 120 may be necessary or required, and how user-level QoS of a corresponding application or service may be optimized during the vertical handoff process. The local network connection database 212 may be updated or refined as a needed basis or periodically.

The host processor 214 may comprise suitable logic, circuitry, interfaces and/or code that may be operable to manage and/or control operations of associated device component units such as, for example, the WLAN transceiver 202, the Bluetooth transceiver 204, the CDMA transceiver 206, the UMTS transceiver 208, and the WiMAX transceiver 210 depending on usages. For example, the host processor 214 may be operable to activate or deactivate one or more associated radios such as the Bluetooth transceiver 204 and/or the UMTS transceiver 208 as a needed basis to save power and/or support a vertical handoff in the heterogeneous network system 120. The host processor 214 may be operable to carry out power measurement on data transmissions of an on-going wireless communication session from a current serving access network such as the UMTS network 124. In instance where the power measurement may be lower than an acceptable power threshold value, the host processor 214 may be operable to communicate with the location server 130 and/or the local NW connection database 212 to acquire location-based network connection information in the vicinity or proximity of the current location of the multi-radio mobile device 200. The acquired location-based network connection information may provide network connection information such as call drop or service loss, and/or connection QoS in one or more available networks in the current location of the multi-radio mobile device 200 and/or surrounding areas.

The host processor 214 may be operable to determine whether a vertical handoff may be required in order to continue the on-going wireless communication session based on the acquired location-base network connection information. In instances where the acquired location-based network connection information may indicate a low call drop or service loss rate in the vicinity or proximity of the current location of the multi-radio mobile device 200. The host processor 214 may be operable to continue receiving the wireless communication session in the current serving network such as the UMTS network 124 regardless of the low received signal power in the UMTS network 124. In instances where acquired location-based network connection information indicates a high call drop or service loss rate in the vicinity or proximity of the current location of the multi-radio mobile device 200 and the multi-radio mobile device 200 is passing the UMTS network 124 fast, the multi-radio mobile device 200 may still stay with the UMTS network 124 as long as possible so as to save power even with a lower data rate. In instances where the acquired location-based network connection information indicates a high call drop or service loss rate in the vicinity or proximity of the current location of the multi-radio mobile device 200, the host processor 214 may be operable to determine to hand off the on-going wireless communication session from the current serving access network, namely, the UMTS network 124, to a target access network associated with an acceptable or enhanced user-level QoS in the vicinity or proximity of the current location of the multi-radio mobile device 200. In this regard, the host processor 214 may be operable to identify one or more available access networks associated with lower call drop rates or service loss rates in the vicinity or proximity of the current location of the multi-radio mobile device 200 based on the acquired location-based network connection information. An access network associated with the highest connection QoS in the vicinity or proximity of the current location of the multi-radio mobile device 200 may be selected, from the identified one or more networks, as the target access network.

The host processor 214 may be configured to adapt user-level QoS for the on-going wireless communication session to the connection QoS of the selected target access network. In instances where the connection QoS of the selected target access network may match the current user-level QoS for the on-going wireless communication session, the host processor 214 may remain the current user-level QoS fixed during the handoff process. In instances where the connection QoS of the selected target access network may fail to fulfill the current user-level QoS for the on-going wireless communication session, the host processor 214 may be operable to downgrade or scale down the current user-level QoS based on the connection QoS of the selected target access network. In this scenario, the current user-level QoS is refreshed or changed during the handoff process. In instances where the connection QoS of the selected target access network may exceed the user-level QoS for the on-going wireless communication session, the host processor 214 may be operable to upgrade or scale up the current user-level QoS based on the connection QoS of the selected target access network.

The host processor 214 may be operable to communicate the selected target access network such as the WLAN 121 to establish connections with the selected target access network for the on-going wireless communication session. The current serving access network may be replaced by the selected target access network to continue the reception of the on-going wireless communication session on the multi-radio mobile device 200. The host processor 214 may be operable to receive corresponding data transmissions via, for example, the WLAN transceiver 202 from the new serving access network, namely, the WLAN 121. The host processor 214 may be operable to store the handoff information and/or connection QoS information in the corresponding location of the multi-radio mobile device 200 into the local NW connection database 212. The host processor 214 may be operable to transmit the stored handoff information and/or connection QoS information to the location server 130 so as to refine or update the reference database 132. The host processor 214 may be operable to communicate with the location server 130 for location-based network connection information as a needed basis or periodically.

The memory 216 may comprise suitable logic, circuitry, interfaces and/or code that may be operable to store information such as executable instructions and data that may be utilized by the host processor 214 and/or other associated component units such as, for example, the WLAN transceiver 202 and the Bluetooth transceiver 204. The memory 216 may comprise RAM, ROM, low latency nonvolatile memory such as flash memory and/or other suitable electronic data storage.

In an exemplary operation, the host processor 214 may be operable to manage and control operations of, for example, the WLAN transceiver 202 and the UMTS transceiver 208, depending on corresponding usages. The host processor 214 may be operable to process data transmissions of an on-going wireless communication session received from a current serving access network such as the UMTS network 124. For example, the host processor 214 may be operable to carry out power measurement on the received data transmissions. The host processor 214 may be operable to monitor the power measurement to ensure an uninterrupted reception of the on-going wireless communication session on the multi-radio mobile device 200. In instances where the power measurement may be lower than an acceptable power threshold value, the host processor 214 may be operable to acquire location-based network connection information in the vicinity or proximity of the current location of the multi-radio mobile device 200.

The host processor 214 may be operable to determine whether a vertical handoff may be needed for the on-going wireless communication session based on the acquired location-based network connection information. In instances where the acquired location-based network connection information may indicate a low call drop or service loss rate in the current serving access network, the host processor 214 may be operable to manage the multi-radio mobile device 200 to continue receiving data transmission of the on-going wireless communication session from the current serving network regardless of low received signal power. Otherwise, the host processor 214 may be operable to perform a vertical handoff to continue receiving the on-going wireless communication session via a different radio access network, especially when the multi-radio mobile device 200 is slowly passing the UMTS network 124. In this regard, the host processor 214 may be operable to identify one or more available access networks associated with lower call drop rates or service loss rates in the vicinity or proximity of the current location of the multi-radio mobile device 200 based on the acquired location-based network connection information.

A target access network such as the WLAN 121 with the highest connection QoS may be selected from the identified available access networks. The host processor 214 may be operable to manage or optimize user-level QoS to continue receiving the on-going wireless communication session based on the connection QoS of the selected target access network. In instances where the user-level QoS may match the connection QoS of the selected target access network, the user-level QoS may remain fixed during the handoff process. In instances where the connection QoS of the selected target access network may exceed the user-level QoS for the on-going wireless communication session, the host processor 214 may be operable to upgrade the user-level QoS based on the connection QoS of the selected target access network. In instances where the connection QoS of the selected target access network may fail to fulfill the user-level QoS for the on-going wireless communication session, the host processor 214 may be operable to downgrade the user-level QoS based on the connection QoS of the selected target access network. The host processor 214 may be operable to establish corresponding QoS enabled connections with the selected target access network, for example, the WLAN 121 for handing off the on-going wireless communication session from the current serving access network such as, for example, the UMTS network 124. The host processor 214 may be operable to use the WLAN 121 as a new serving access network. The WLAN transceiver 202 may be configured to receive data transmissions of the on-going wireless communication session with the completion of the vertical handoff process.

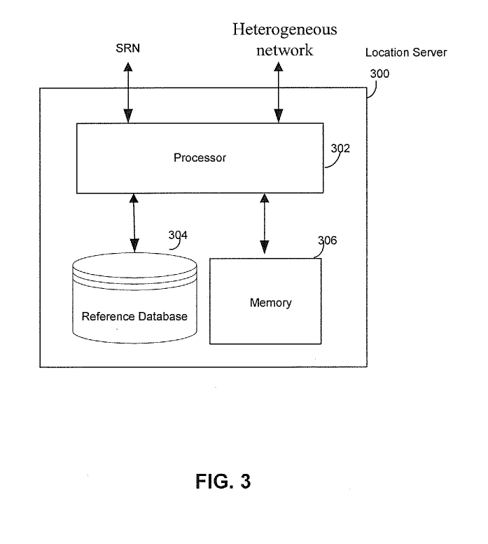

FIG. 3 is a block diagram illustrating an exemplary location server that is operable to provide location-based network connection information to associated mobile devices to optimize user-level QoS during a location-based vertical handoff, in accordance with an embodiment of the invention. Referring to FIG. 3, there is shown a location server 300. The location server 300 may comprise a processor 302, a reference database 304 and a memory 306.

The processor 302 may comprise suitable logic, circuitry, interfaces and/or code that may be operable to manage and/or control operations of the reference database 304 and the memory 306. The processor 302 may be operable to communicate with the satellite reference network (SRN) 150 so as to collect GNSS satellite data by tracking GNSS constellations through the SRN 150. The processor 302 may be operable to utilize the collected GNSS satellite data to build the reference database 304, which may be coupled internally or externally to the location server 300. The processor 302 may also be operable to receive or collect location-based network connection information from a plurality of associated communication devices such as the multi-radio mobile device 110. The collected location-based network connection information may comprise network connection information such as call drop or service loss, and/or connection QoS in certain locations. The processor 302 may be operable to store the collected location-based network connection information into the reference database 304. The processor 302 may be operable to share the stored location-based network connection information among the plurality of associated communication devices. The processor 302 may be operable to communicate the stored location-based network connection information as GNSS assistance data with one or more associated communication devices such as the multi-radio mobile device 200 as a needed basis or periodically.

The memory 306 may comprise suitable logic, circuitry, interfaces and/or code that may be operable to store information such as executable instructions and data that may be utilized by the processor 302 and/or other associated component units such as, for example, the reference database 304. The memory 306 may comprise RAM, ROM, low latency nonvolatile memory such as flash memory and/or other suitable electronic data storage.

In an exemplary operation, the processor 302 may be operable to collect GNSS satellite data through the SRN 150 to build the reference database 304. The processor 302 may be operable to collect location-based network connection information from a plurality of associated communication devices such as the multi-radio mobile device 110. The processor 302 may be operable to generate GNSS assistance data using the collected GNSS satellite data and/or the collected location-based network connection information. The generated GNSS assistance data may be stored in the reference database 304. In instances where one or more requests for GNSS assistance data, specifically for location-based network connection information, may be received from, for example, the multi-radio mobile device 110 located at a specific location. The processor 302 may be operable to acquire GNSS assistance data for the multi-radio mobile device 110 from the reference database 304 with respect to the specific location. The acquired GNSS assistance data may comprise, for example, network connection information such as, for example, call drop or service loss, and/or connection QoS, in the vicinity or proximity of the specific location. The processor 302 may be operable to communicate the acquired GNSS assistance data to the multi-radio mobile device 200. The acquired GNSS assistance data may be utilized by the multi-radio mobile device 200 to determine whether a vertical handoff may be performed over an on-going wireless communication session on the multi-radio mobile device 200, and how user-level QoS may be managed and/or optimized during the vertical handoff process.

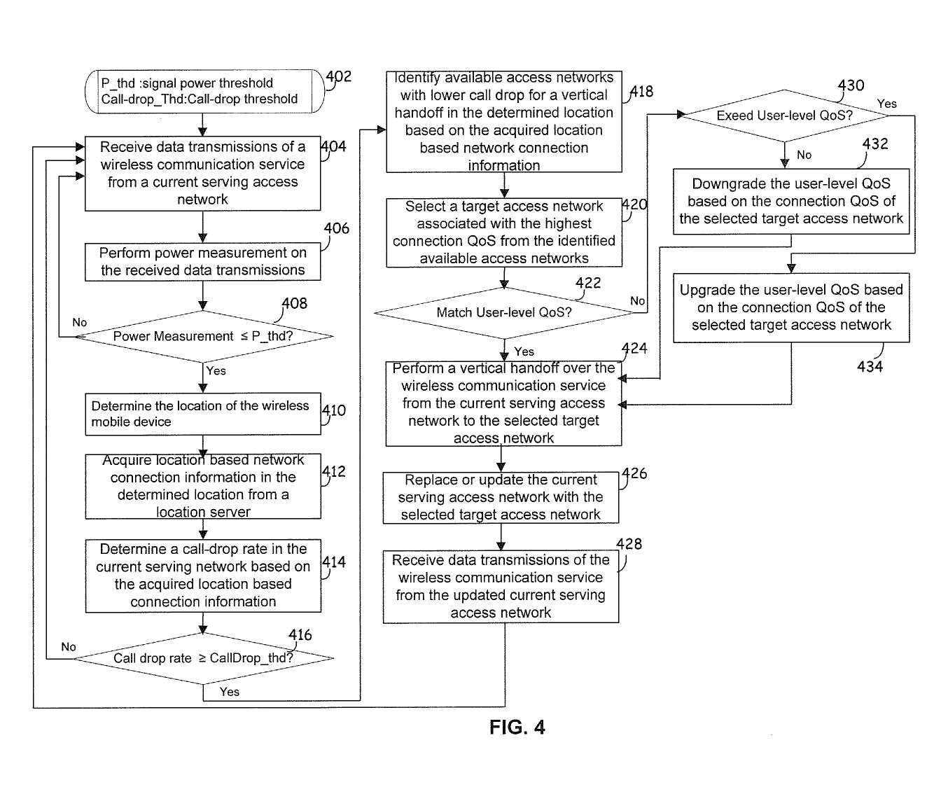

FIG. 4 is a flow chart illustrating an exemplary procedure that is utilized to optimize user-level QoS during a location-based vertical handoff in a heterogeneous network system, in accordance with an embodiment of the invention. Referring to FIG. 4, the exemplary steps may start with step 402. In step 402, the parameter P_thd represents a signal power threshold value for a vertical handoff. The parameter Call-drop_thd represents a threshold value for a call drop rate or a connection loss rate. In step 404, the multi-radio mobile device 200 may be operable to receive data transmissions of a wireless communication session from a serving access network. In step 406, the multi-radio mobile device 200 may be operable to perform power measurement on the received data transmissions of the wireless communication session. In step 408, it may be determined whether the power measurement is less than or equal to P_thd. In instances where the power measurement is less than or equal to P_thd, then in step 410.

In step 410, the multi-radio mobile device 200 may be operable to determine its own location. In step 412, the multi-radio mobile device 200 may be operable to communicate with the location server 300 to acquire network connection information in the determined location of the multi-radio mobile device 200, and/or surrounding areas. In step 414, the multi-radio mobile device 200 may be operable to determine a call-drop rate in the area of the determined location in the serving network based on the acquired network connection information. In step 416, it may be determined whether the determined call-drop rate is greater than or equal to Call-drop_thd. In instances where determined call-drop rate is greater than or equal to Call-drop_thd, then in step 418. In step 418, the multi-radio mobile device 200 may be operable to identify one or more available access networks with lower call drop for a vertical handoff in the determined location-based on the acquired location-base network connection information. In step 420, the multi-radio mobile device 200 may be operable to select a target access network associated with the highest connection QoS from the identified available access networks. In step 422, it may be determined whether the connection QoS of the selected target access network may match user-level QoS. In instances where the connection QoS may match the user-level QoS, then in step 424, the multi-radio mobile device 200 may be operable to perform a vertical handoff over the wireless communication session from the current serving access network to the selected target access network. In step 426, the current serving access network may be replaced by the selected target access network. In step 428, the multi-radio mobile device 200 may be operable to receive data transmissions of the wireless communication session from the updated current serving access network. The exemplary steps may return to step 404.

In step 408, in instances where the power measurement is greater than P_thd, then the exemplary steps may return to step 404.

In step 416, in instances where determined call-drop rate is less than Call-drop_thd, then the exemplary steps may return to step 404.

In step 422, in instances where the connection QoS may not match the user-level QoS, then in step 430, it may be determined whether the connection QoS of the selected target access network may exceed the user-level QoS. In instances where the connection QoS of the selected target access network may exceed the user-level QoS, the multi-radio mobile device 200 may be operable to upgrade the user-level QoS based on the connection QoS of the selected target access network. The exemplary steps may return to step 424.

In step 430, in instances where the connection QoS of the selected target access network may fail to fulfill the user-level QoS, the multi-radio mobile device 200 may be operable to downgrade the user-level QoS based on the connection QoS of the selected target access network. The exemplary steps may return to step 424.

Although optimization of user-level QoS during a location-based vertical handoff in a heterogeneous network system is illustrated in FIG. 4, the invention need not be so limited. Accordingly, user-level QoS may be optimized during a location-based homogenous handoff, namely, a location-based handoff between the same radio access technologies, to handoff an on-going wireless communication session from a current serving base station to a different base station within the same access network without departing from the spirit and scope of various embodiments of the invention.

In various exemplary aspects of the method and system for optimizing user-level QoS during a location-based handoff over heterogeneous mobile environments, a wireless multi-radio mobile device such as a multi-radio mobile device 110 may be operable to receive data transmissions of a wireless communication session from a serving access network such as the UMTS network 124 in a heterogeneous network system such as the heterogeneous network system 120. The wireless mobile device 110 may be communicatively coupled to the heterogeneous network system 120 comprising a plurality of difference access networks such as, for example, the WLAN 121 and/or the UMTS network 124. The multi-radio mobile device 110 may be operable to perform a vertical handoff, from the serving access network to another one of the plurality of different access networks, over the wireless communication session based on the received data transmissions. User-level QoS for the wireless communication session may be adjusted based on connection QoS information for a current location of the multi-radio mobile device 110 during the vertical handoff.

The multi-radio mobile device 110 may be operable to acquire location-based network connection information, in the vicinity or proximity of the current location of the multi-radio mobile device 110, from the location server 130 when need. The acquired location-based network connection information comprises call drop or service loss information and the connection QoS information in the current location of the multi-radio mobile device 110. One or more available access networks may be identified based on the call drop information. A target access network that comprises the highest connection QoS may be selected from the identified one or more available access networks based on the connection QoS information.

The multi-radio mobile device 110 may be operable to adapt the user-level QoS to connection QoS of the selected target access network (the highest connection QoS) during the vertical handoff. In instances where the highest connection QoS may match the user-level QoS, the multi-radio mobile device 110 may be operable to remain the user-level QoS fixed during the vertical handoff. In instances where the highest connection QoS may exceed the user-level QoS, the multi-radio mobile device 110 may be operable to upgrade the user-level QoS based on the highest connection QoS and/or an actual velocity of the multi-radio mobile device 110. In instances where the highest connection QoS may fail to fulfill the user-level QoS, the multi-radio mobile device 110 may be operable to downgrade the user-level QoS during the vertical handoff and/or an actual velocity of the multi-radio mobile device 110. The multi-radio mobile device 110 may complete the vertical handoff process with receiving data transmission of the wireless communication session from the selected target access network (as a new serving access network) using the adapted user-level QoS.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for optimizing user-level QoS during a location-based handoff over heterogeneous mobile environments.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a wireless multi-radio mobile that is communicatively coupled with a heterogeneous network system, wherein said heterogeneous network system comprises a plurality of different access networks:
receiving data transmissions for a wireless communication session from a serving access network, which is one of said plurality of different access networks;
performing a handoff, from said serving access network to another one of said plurality of different access networks or to a different base station within said serving access network, over said wireless communication session in said heterogeneous network system based on said received data transmissions; and
adjusting user-level QoS for said wireless communication session based on connection QoS information for a current location of said wireless multi-radio mobile device during said handoff.

2. The method according to claim 1, comprising acquiring location-based network connection information in the vicinity of said current location of said wireless multi-radio mobile device from a location server for said handoff, wherein said acquired location-based network connection information comprise call drop information and said connection QoS information in said current location of said wireless multi-radio mobile device.

3. The method according to claim 2, comprising identifying one or more available access networks from said plurality of different access networks based on said call drop information.

4. The method according to claim 3, comprising selecting a target access network from said identified one or more available access networks based on said connection QoS information.

5. The method according to claim 4, wherein said selected target access network comprises a highest connection QoS among said identified one or more available access networks.

6. The method according to claim 5, comprising adapting said user-level QoS to said highest connection QoS during said handoff.

7. The method according to claim 6, comprising maintaining said user-level QoS a fixed value during said handoff if said highest connection QoS matches said user-level QoS.

8. The method according to claim 6, comprising upgrading said user-level QoS during said handoff if said highest connection QoS exceeds said user-level QoS; and downgrading said user-level QoS during said handoff if said highest connection QoS fails to fulfill said user-level QoS.

9. The method according to claim 6, comprising adapting said user-level QoS based on an actual velocity of said wireless multi-radio mobile device.

10. The method according to claim 6, comprising adapting said user-level QoS to match corresponding connection QoS of said different base station within said serving access network during said handoff.

11. A system for communication, the system comprising:
one or more processors and/or circuits for use in a wireless multi-radio mobile device for communicative coupling with a heterogeneous network system, wherein said heterogeneous network system comprises a plurality of different access networks, said one or more processors and/or circuits being operable to:
receive data transmissions for a wireless communication session from a serving access network, which is one of said plurality of different access networks;
perform a handoff, from said serving access network to another one of said plurality of different access networks or to a different base station within said serving access network, over said wireless communication session in said heterogeneous network system based on said received data transmissions; and
adjust user-level QoS for said wireless communication session based on connection QoS information in current location of said wireless multi-radio mobile device during said handoff.

12. The system according to claim 11, wherein said one or more processors and/or circuits are operable to acquire location-based network connection information in vicinity of said current location of said wireless multi-radio mobile device from a location server for said handoff, wherein said acquired location-based network connection information comprise call drop information and said connection QoS information in said current location of said wireless multi-radio mobile device.

13. The system according to claim 12, wherein said one or more processors and/or circuits are operable to identify one or more available access networks from said plurality of different access networks based on said call drop information.

14. The system according to claim 13, wherein said one or more processors and/or circuits are operable to select a target access network from said identified one or more available access networks based on said connection QoS information.

15. The system according to claim 14, wherein said selected target access network comprises a highest connection QoS among said identified one or more available access networks.

16. The system according to claim 15, wherein said one or more processors and/or circuits are operable to adapt said user-level QoS to said highest connection QoS during said handoff.

17. The system according to claim 16, wherein said one or more processors and/or circuits are operable to maintain said user-level QoS a fixed value during said handoff if said highest connection QoS matches said user-level QoS.

18. The system according to claim 16, wherein said one or more processors and/or circuits are operable to upgrade said user-level. QoS during said handoff if said highest connection QoS exceeds said user-level QoS; and to downgrade said user-level QoS during said handoff if said highest connection QoS fails to fulfill said user-level QoS.

19. The system according to claim 16, wherein said one or more processors and/or circuits are operable to adapt said user-level QoS based on an actual velocity of said wireless multi-radio mobile device.

20. The system according to claim 16, wherein said one or more processors and/or circuits are operable to adapt said user-level QoS to match corresponding connection QoS of said different base station within said serving access network during said handoff.
